(19) United States
(12) Patent Application Publication
(10) Pub. No.: US 2024/0244011 A1
(43) Pub. Date: Jul. 18, 2024

(54) Data Sending Control Method and Data Sending Control System Capable of Dynamically Allocating Log Data

(71) Applicant: MEDIATEK INC., Hsin-Chu (TW)

(72) Inventors: Yung-Chi Chen, Hsinchu City (TW); Guan-Ren Chen, Hsinchu City (TW)

(73) Assignee: MEDIATEK INC., Hsin-Chu (TW)

(21) Appl. No.: 18/098,120

(22) Filed: Jan. 18, 2023

(51) Int. Cl. H04L 47/70; H04L 47/52; H04L 47/80

(52) U.S. Cl. CPC H04L 47/822; H04L 47/521; H04L 47/805

(57) ABSTRACT

A data sending control method includes acquiring log data of a plurality of log sources by a log classifier module, acquiring a plurality of system conditions by a priority decision maker module, generating log source priority information by the priority decision maker module according to the plurality of system conditions, dispatching the log data of the plurality of log sources to at least one corresponding data block in a priority queue by the log classifier module according to the log source priority information and queue priority information, periodically scanning the priority queue, allocating the log data of the at least one corresponding data block to a transmitting queue by a log sending scheduler module, and outputting the allocated log data buffered in the transmitting queue.

### BACKGROUND

With the development of technology, network log messages, modem log messages, and user configuration log messages are required to be analyzed for optimizing communication quality and resource allocations. In conventional log message communications, log queuing scheduling policy is a first-come-first-serve (FCFS) mechanism. Further, a log bandwidth is controlled by a passive method, such as using filter controlled mechanism. Log buffer sizes are fixed for allocating predefined configurations.

As a result, in the conventional log message communications, when a certain log user is required to send large log data, bandwidth interference may occur by other log users. Further, the filter controlled mechanism lacks capability of limiting log bandwidth on a specific channel level. Additionally, fixed Log buffer sizes result in poor utilization, especially in some log sources having lower throughput.

Therefore, to develop a data sending control method capable of dynamically allocating log data and dynamically adjusting buffer sizes is an important issue.

### SUMMARY

In an embodiment of the present invention, a data sending control method is disclosed. The data sending control method comprises acquiring log data of a plurality of log sources by a log classifier module, acquiring a plurality of system conditions by a priority decision maker module, generating log source priority information by the priority decision maker module according to the plurality of system conditions, dispatching the log data of the plurality of log sources to at least one corresponding data block in a priority queue by the log classifier module according to the log source priority information and queue priority information, periodically scanning the priority queue, allocating the log data of the at least one corresponding data block to a transmitting queue by a log sending scheduler module, and outputting the allocated log data buffered in the transmitting queue.

In another embodiment of the present invention, a data sending control system is disclosed. The data sending control system comprises a plurality of log sources configured to output log data, a priority decision maker module configured to acquire a plurality of system conditions, a log classifier module linked to the plurality of log sources and the priority decision maker module, a priority queue linked to the log classifier module and the priority decision maker module and configured to buffer the log data, a log sending scheduler module linked to the priority queue and configured to scan the priority queue, and a transmitting queue linked to the log sending scheduler module. The log data of the plurality of log sources are acquired by the log classifier module. The priority decision maker module generates log source priority information according to the plurality of system conditions. The log classifier module dispatches the log data of the plurality of log sources to at least one corresponding data block in the priority queue according to the log source priority information and queue priority information. The log sending scheduler module periodically scans the priority queue. The log sending scheduler module allocates the log data of the at least one corresponding data block to the transmitting queue. The log sending scheduler module controls the transmitting queue for outputting the allocated log data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a data sending control system according to an embodiment of the present invention.

FIG. 2 is a flow chart of allocating a priority queue of the data sending control system in FIG. 1.

FIG. 3 is a flow chart of performing a data sending control method by the data sending control system in FIG. 1.

### DETAILED DESCRIPTION

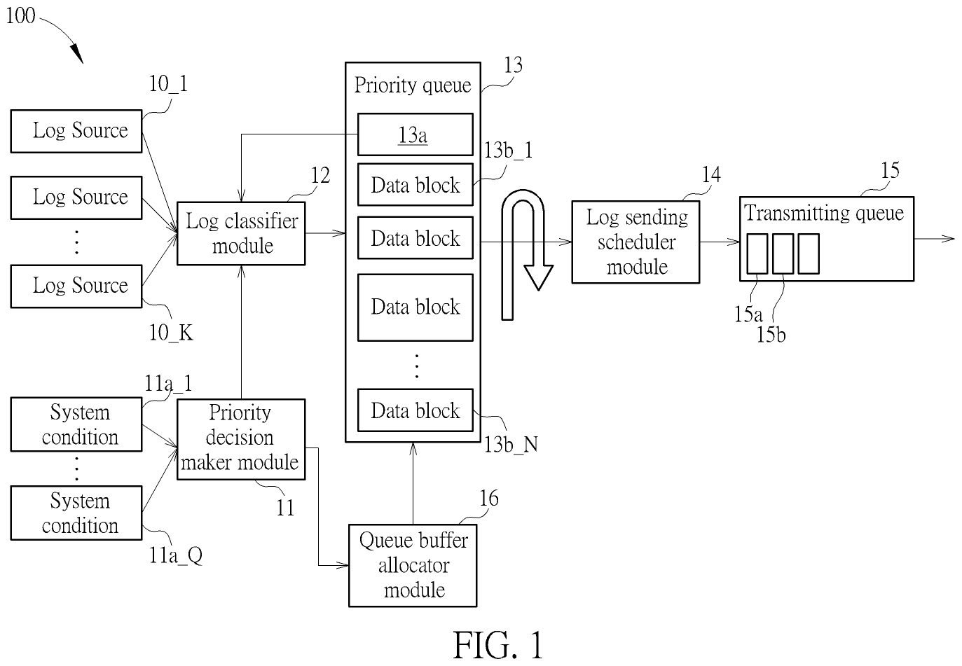

FIG. 1 is a block diagram of a data sending control system 100 according to an embodiment of the present invention. The data sending control system 100 can be applied to network log data communications. The log data can include network information, link configurations, and data traffic status information, but is not limited thereto. The data sending control system 100 includes a plurality of log sources 10_1 to 10_K, a priority decision maker module 11, a log classifier module 12, a priority queue 13, a log sending scheduler module 14, and a transmitting queue 15. The plurality of log sources 10_1 to 10_K can correspond to K log users. The plurality of log sources 10_1 to 10_K can output log data. Further, each log source of the plurality of log sources 10_1 to 10_K has a priority tag for identifying a trace priority. The priority decision maker module is used for acquiring a plurality of system conditions 11a_1 to 11a_Q. The log classifier module 12 is linked to the plurality of log sources 10_1 to 10_K and the priority decision maker module 11. The priority queue 13 is linked to the log classifier module 12 and the priority decision maker module 11 for buffering the log data. The log sending scheduler module 14 is linked to the priority queue 13 for scanning the priority queue 13. The transmitting queue 15 is linked to the log sending scheduler module 14. In the data sending control system 100, the log data of the plurality of log sources 10_1 to 10_K are acquired by the log classifier module 12. The priority decision maker module 11 can generate log source priority information according to the plurality of system conditions 11a_1 to 11a_Q. Here, the system conditions 11a_1 to 11a_Q can include priority tag information of the log sources 10_1 to 10_K, total buffer requirements, runtime information, CPU speed information, and/or any fixed or dynamic system configurations. The log classifier module 103 dispatches the log data of the plurality of log sources 10_1 to 10_K to at least one corresponding data block 13b_1 to 13b_N in the priority queue 13 according to the log source priority information and queue priority information. The log sending scheduler module 14 can periodically scan the priority queue 13. Then, the log sending scheduler module 14 can allocate the log data of the at least one corresponding data block 13b_1 to 13b_N to the transmitting queue 15. The log sending scheduler module 14 can control the transmitting queue 15 for outputting the allocated log data. Briefly, instead of directly buffering the log data of the log sources 10_1 to 10_K for performing a first-in first-out (FIFO) output mechanism, in the data sending control system 100, the log data of the log sources 10_1 to 10_K can be reallocated according to priority information for outputting to the priority queue 13. Thus, transmission of the log data of the log sources 10_1 to 10_K can be optimized. Here, K, Q, and N are positive integers.

In the data sending control system 100, a queue buffer allocator module 16 can be introduced. The queue buffer allocator module 16 is linked to the priority queue 13 and the priority decision maker module 11. The queue buffer allocator module 16 can generate a queue control signal according to the source priority information outputted from the priority decision maker module 11. Further, an allocation information table 13a can be introduced in the priority queue 13. The queue priority information can be generated by using an allocation information table 13a according to the queue control signal. For example, the allocation information table can include configurations of number of data blocks, configurations of sizes of the data blocks, and/or configurations of an initial address of each data block. Further, at least one data block (or say, memory segment) 13b_1 to 13b_N can be dynamically adjusted. For example, the queue buffer allocator module 16 can generate the queue control signal according to the source priority information. Then, the at least one data block 13b_1 to 13b_N in the priority queue 13 can be dynamically allocated after the queue control signal is generated. For example, the priority queue 13 can be adjusted according to the configurations of number of data blocks, the configurations of sizes of the data blocks, and/or the configurations of an initial address of each data block in the allocation information table 13a through the queue control signal.

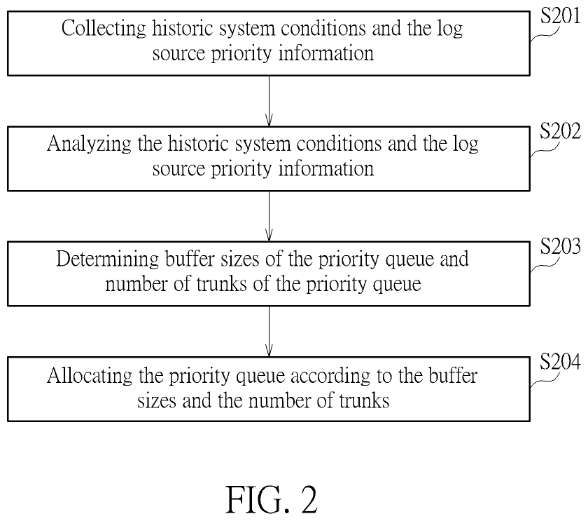

FIG. 2 is a flow chart of allocating the priority queue 13 of the data sending control system 100. In one embodiment, the priority queue 13 can be pre-allocated according to historic system conditions, as the following steps:
S201: collecting historic system conditions and the log source priority information;
S202: analyzing the historic system conditions and the log source priority information;
S203: determining buffer sizes of the priority queue and number of trunks of the priority queue;
S204: allocating the priority queue according to the buffer sizes and the number of trunks.

In step S201, the queue buffer allocator module 16 can collect historic system conditions and the log source priority information. Here, the historic system conditions can be regarded as statistic data, such as historic priority of each log source, historic throughput or bandwidth utilization of each log source, and/or historic system configurations. In step S202, the queue buffer allocator module 16 can analyze the historic system conditions and the log source priority information. After the historic system conditions and the log source priority information are analyzed, the queue buffer allocator module 16 can determine buffer sizes of the priority queue 13 and number of trunks of the priority queue 13. Then, the priority queue 13 can be allocated according to the buffer sizes and the number of trunks. Since at least one data block 13b_1 to 13b_N can be allocated, unitization of the priority queue 13 can be optimized.

In the data sending control system 100, as previously illustrated, each log source of the plurality of log sources 10_1 to 10_K has the priority tag for identifying a trace priority. The priority tag can be predetermined. The priority tags can be used by the log classifier module 12 for dispatching the log data of the plurality of log sources 10_1 to 10_K to different addresses of the priority queue. For example, after the priority queue 13 is optimized by allocating data blocks 13b_1 to 13b_N with different buffer sizes and addresses, the data blocks 13b_1 to 13b_N can be used for buffering appropriate log data of the plurality of log sources 10_1 to 10_K with different priority. Further, in the data sending control system 100, a plurality of weightings of the plurality of system conditions 11a_1 to 11a_Q can be introduced. For example, when a priority of a system condition is increased, a weighting of the system condition is increased. When a priority of a system condition is decreased, a weighting of the system condition is decreased. In other words, a priority of a system condition is positively correlated to a weighting of the system condition.

In the data sending control system 100, after the log sending scheduler module 14 scans the priority queue 13, the log sending scheduler module 14 can acquire Quality of Service (Qos) information. Then, the log sending scheduler module 14 can analyze the Qos information for allocating the log data of the at least one corresponding data block to the transmitting queue 15. For example, after the QoS information is analyzed by the log sending scheduler module 14, when first log data 15b of a first data block has higher priority than second log data 15a of the second data block, the first log data 15b of the first data block can be selected from the priority queue 13 first. Then, the first log data 15b of the first data block can be transmitted to the transmitting queue 15. Then, the second log data 15a of the second data block can be selected from the priority queue 13. The second log data 15a of the second data block can be transmitted to the transmitting queue 15 after the first log data 15b is buffered in the transmitting queue 15. Specifically, the allocated log data buffered in the transmitting queue 15 having different addresses can be outputted by a first-in first-out (FIFO) mechanism. For example, the transmitting queue 15 outputs the first log data 15b. Then, after the first log data 15b is outputted, the second log data 15a is outputted from the transmitting queue 15. However, the scheduling policy of the data sending control system 100 can be the QoS scheduling algorithm, but is not limited thereto. For example, weighted round robin (WRR) information and logical channel periodization (LCP) information can be used for selecting appropriate log data from the priority queue 13 to the transmitting queue 15.

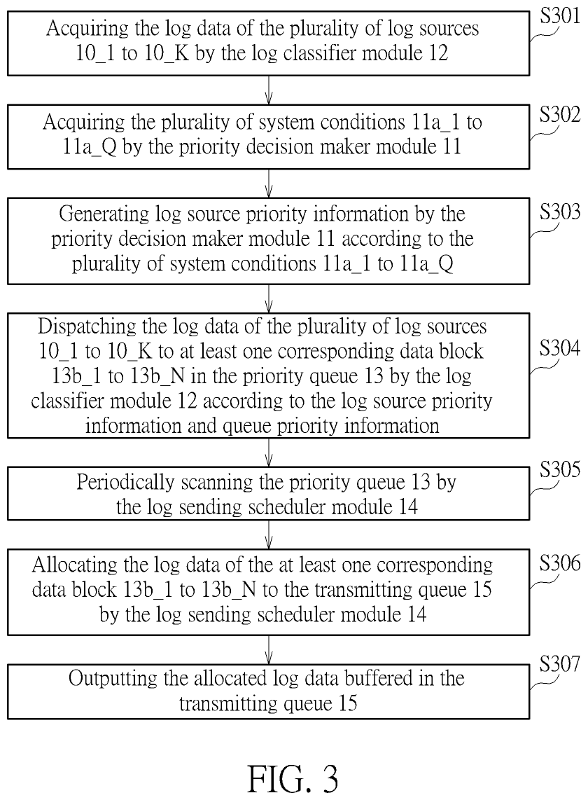

FIG. 3 is a flow chart of performing a data sending control method by the data sending control system 100. The data sending control method includes step S301 to step S307. Any reasonable technology modification falls into the scope of the present invention. Step S301 to step S307 are illustrated below.
step S301: acquiring the log data of the plurality of log sources 10_1 to 10_K by the log classifier module 12;
step S302: acquiring the plurality of system conditions 11a_1 to 11a_Q by the priority decision maker module 11;
step S303: generating log source priority information by the priority decision maker module 11 according to the plurality of system conditions 11a_1 to 11a_Q;
step S304: dispatching the log data of the plurality of log sources 10_1 to 10_K to at least one corresponding data block 13b_1 to 13b_N in the priority queue 13 by the log classifier module 12 according to the log source priority information and queue priority information;
step S305: periodically scanning the priority queue 13 by the log sending scheduler module 14;
step S306: allocating the log data of the at least one corresponding data block 13b_1 to 13b_N to the transmitting queue 15 by the log sending scheduler module 14;
step S307: outputting the allocated log data buffered in the transmitting queue 15.

Details of step S301 to step S307 are previously illustrated. Thus, they are omitted here. In the data sending control system 100, since the log data of the plurality of log sources can be allocated according each log source priority. The information loss of the log data of the plurality of log sources can be minimized. Further, since the priority queue can be optimized by allocating data blocks according to the historic system conditions and the log source priority information, the utilization of the priority queue can be improved.

To sum up, the present invention discloses a data sending control system and a data sending control method. The data sending control system introduces the priority decision maker module and the queue buffer allocator module. Therefore, the log data of the plurality of log sources can be appropriately allocated. The priority queue can also be optimized by allocating data blocks according to the historic system conditions and the log source priority information. Instead of directly buffering the log data of the log sources for performing the FIFO output mechanism, in the data sending control system 100, the log data of the log sources can be allocated according to priority information for outputting to the priority queue. As a result, the information loss of the log data of the plurality of log sources can be minimized. The utilization of the priority queue can be improved.

Those skilled in the art will readily observe that numerous modifications and alterations of the device and method may be made while retaining the teachings of the invention. Accordingly, the above disclosure should be construed as limited only by the metes and bounds of the appended claims.

1. A data sending control method comprising:
acquiring log data of a plurality of log sources by a log classifier module;
acquiring a plurality of system conditions by a priority decision maker module;
generating log source priority information by the priority decision maker module according to the plurality of system conditions;
generating a queue control signal by a queue buffer allocator module according to the log source priority information;
generating queue priority information by using an allocation information table according to the queue control signal;
dispatching the log data of the plurality of log sources to at least one corresponding data block in a priority queue by the log classifier module according to the log source priority information and the queue priority information;
periodically scanning the priority queue;
allocating the log data of the at least one corresponding data block to a transmitting queue for generating allocated log data by a log sending scheduler module; and
outputting the allocated log data in the transmitting queue;
wherein the allocation information table comprises configurations of number of data blocks, configurations of sizes of the data blocks, and/or configurations of an initial address of each data block.

2-3. (canceled)

4. The method of claim 1, further comprising:
dynamically allocating at least one data block in the priority queue according to the queue control signal.

5. The method of claim 1, further comprising: generating a plurality of weightings of the plurality of system conditions;
wherein a priority of a system condition is positively correlated to a weighting of the system condition.

6. The method of claim 1, further comprising:
acquiring Quality of Service (Qos) information by the log sending scheduler module; and
analyzing the QoS information for allocating the log data of the at least one corresponding data block to the transmitting queue.

7. The method of claim 1, wherein allocating the log data of the at least one corresponding data block to the transmitting queue comprises:
selecting first log data of a first data block having higher priority from the priority queue;
selecting second log data of a second data block having lower priority from the priority queue;
transmitting the first log data of the first data block to the transmitting queue; and
transmitting the second log data of the second data block to the transmitting queue after the first log data is buffered in the transmitting queue.

8. The method of claim 1, further comprising:
collecting historic system conditions and the log source priority information;
analyzing the historic system conditions and the log source priority information;
determining buffer sizes of the priority queue and number of trunks of the priority queue; and
allocating the priority queue according to the buffer sizes and the number of trunks.

9. The method of claim 1, wherein each log source of the plurality of log sources has a priority tag for identifying a trace priority, and priority tags are used by the log classifier module for dispatching the log data of the plurality of log sources to different addresses of the priority queue.

10. The method of claim 1, wherein outputting the allocated log data buffered in the transmitting queue comprises:
outputting the allocated log data buffered in the transmitting queue having different addresses by a first-in first-out (FIFO) mechanism.

11. A data sending control system comprising:
a plurality of log sources configured to output log data;
a priority decision maker module configured to acquire a plurality of system conditions;
a log classifier module linked to the plurality of log sources and the priority decision maker module;
a priority queue linked to the log classifier module and the priority decision maker module and configured to buffer the log data;
a queue buffer allocator module linked to the priority queue and the priority decision maker;
a log sending scheduler module linked to the priority queue and configured to scan the priority queue; and
a transmitting queue linked to the log sending scheduler module;
wherein the log data of the plurality of log sources are acquired by the log classifier module, the priority decision maker module generates log source priority information according to the plurality of system conditions, the queue buffer allocator module generates a queue control signal according to the log source priority information, and queue priority information is generated by using an allocation information table according to the queue control signal, the log classifier module dispatches the log data of the plurality of log sources to at least one corresponding data block in the priority queue according to the log source priority information and the queue priority information, the log sending scheduler module periodically scans the priority queue, the log sending scheduler module allocates the log data of the at least one corresponding data block to the transmitting queue for generating allocated log data, the log sending scheduler module controls the transmitting queue for outputting the allocated log data, and the allocation information table comprises configurations of number of data blocks, configurations of sizes of the data blocks, and/or configurations of an initial address of each data block.

12-13. (canceled)

14. The system of claim 11,
wherein at least one data block in the priority queue is dynamically allocated according to the queue control signal.

15. The system of claim 11, wherein a plurality of weightings of the plurality of system conditions are generated, and a priority of a system condition is positively correlated to a weighting of the system condition.

16. The system of claim 11, wherein the log sending scheduler module acquires Quality of Service (Qos) information, and the log sending scheduler module analysis the Qos information for allocating the log data of the at least one corresponding data block to the transmitting queue.

17. The system of claim 11, wherein first log data of a first data block having higher priority is selected from the priority queue, second log data of a second data block having lower priority is selected from the priority queue, the first log data of the first data block is transmitted to the transmitting queue, and the second log data of the second data block is transmitted to the transmitting queue after the first log data is buffered in the transmitting queue.

18. The system of claim 11,
wherein the queue buffer allocator module collects historic system conditions and the log source priority information, analysis the historic system conditions and the log source priority information, determines buffer sizes of the priority queue and number of trunks of the priority queue, and allocates the priority queue according to the buffer sizes and the number of trunks.

19. The system of claim 11, wherein each log source of the plurality of log sources has a priority tag for identifying a trace priority, and priority tags are used by the log classifier module for dispatching the log data of the plurality of log sources to different addresses of the priority queue.

20. The system of claim 11, wherein the allocated log data buffered in the transmitting queue having different addresses is outputted by a first-in first-out (FIFO) mechanism.
